(19) United States
(12) Patent Application Publication
(10) Pub. No.: US 2026/0007551 A1
(43) Pub. Date: Jan. 8, 2026

(54) A CUSHION

(71) Applicant: ROLAPAL LIMITED, Auckland (NZ)

(72) Inventor: Roydon SCARLETT, Auckland (NZ)

(21) Appl. No.: 18/994,125

(22) PCT Filed: Jul. 19, 2023
(86) PCT No.: PCT/NZ2023/050070

§ 371 Date: Jan. 14, 2025

(30) Foreign Application Priority Data
Aug. 2, 2022 (AU) 2022211811

(51) Int. Cl. A61G 5/10

(52) U.S. Cl. CPC A61G 5/1048

(57) ABSTRACT

A problem with many known cushions is that they provide insufficient cushioning on account of their internal padding being prone to undesirably moving out of position when pressed on by the weight of the person using them. In preferred embodiments the invention addresses this by way of a cushion 1 that has at least two compartments 2 separated by a wall 3. Each compartment has one or more bladder 5, each of which has a partial fill of fluid that takes up 5%-35% of the volumetric capacity of the bladder. The cushion is formed such that it can be opened to access the bladders and subsequently closed. The cushion also formed so that when it is closed the bladders are not able to move into a neighbouring one of the compartments due, at least in part, to the wall.

### FIELD OF THE INVENTION

This invention relates to cushion having gas filled bladders.

### BACKGROUND

It is known to use cushions, whether they are a free item or form part of a seat or mattress, to provide comfort padding to people. They may for example be used on or as part of a wheelchair, and in particular its backrest or the chair's seat base that receives the person's posterior. A problem with many known cushions is that they provide insufficient cushioning on account of their internal padding being prone to moving too far out of position when pressed on by the weight of the person using them.

### OBJECT OF THE INVENTION

It is an object of preferred embodiments of the invention to go at least some way towards addressing the above problem. While this applies to preferred embodiments, it should be understood that the object of the invention per se is not so limited. It is, simply, to provide a useful choice. Therefore, any object or advantage applicable to any preferred embodiment should not be read-in, or inferred into, any claims expressed more broadly.

### DEFINITIONS

The term “comprising” or “having”, if and when used in this document in relation to a combination of features, should not be seen as excluding the option of additional unspecified features or steps. In other words, the term should not be interpreted in a limiting way.

### SUMMARY OF INVENTION

According to one aspect, the invention is a cushion comprising at least two compartments separated by a wall, each compartment having one or more bladder, each bladder comprising a partial fill of fluid which takes up 5%-35% of the volumetric capacity of the bladder, the cushion being such that it can be opened to access the bladders and subsequently closed, the cushion also being such that when closed the bladders are not able to move into a neighbouring one of the compartments due, at least in part, to the wall.

Optionally the fill in one or more of the bladders takes up 10%-20% of the volumetric capacity of said bladder(s).

Optionally the fill in one or more of the bladders takes up 15%-25% of the volumetric capacity of said bladder(s).

Optionally the fill in one or more of the bladders takes up 10%-15% of the volumetric capacity of said bladder(s).

Optionally the fluid comprises gas.

Optionally the fluid comprises air.

Optionally the bladders are permanently sealed such that fluid cannot be added or to or removed from them.

Optionally there are two, three, four, five or six of the compartments, each compartment having one of more of the bladders.

Optionally there are four of the compartments, each compartment having one of more of the bladders.

Optionally at least one of the compartments contains more of the bladders than another of the compartments.

Optionally there is a a seat comprising one or more of the cushions.

Optionally one or more of the cushions forms part of a backrest of the seat.

Optionally the seat is in the form of a wheelchair.

Optionally the cushion is of sufficient size and with sufficient of the compartments and bladders to provide a mattress.

### DRAWINGS

Some preferred forms of the invention will now be described by way of example and with reference to the accompanying drawings, of which:

FIG. 1 is an isometric view of a cushion that has a series of compartments;

FIG. 2 is a side cross-section view of the cushion; and

FIG. 3 is an isometric view of an air bladder forming part of the cushion.

### DETAILED DESCRIPTION

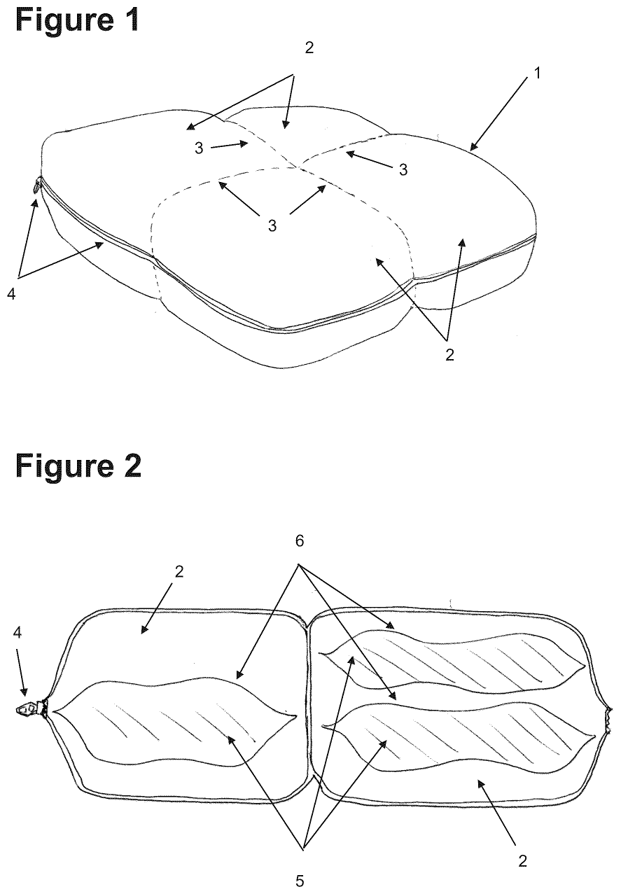

Referring to FIG. 1, the cushion comprises a flexible fabric pouch 1 that has four compartments 2 separated by flexible internal walls 3. In some embodiments the compartments may be in the form of pockets. The general position of the walls is indicated by broken lines. The cushion also incorporates a zipper mechanism 4 around its side so that it can be opened to expose the four compartments 2.

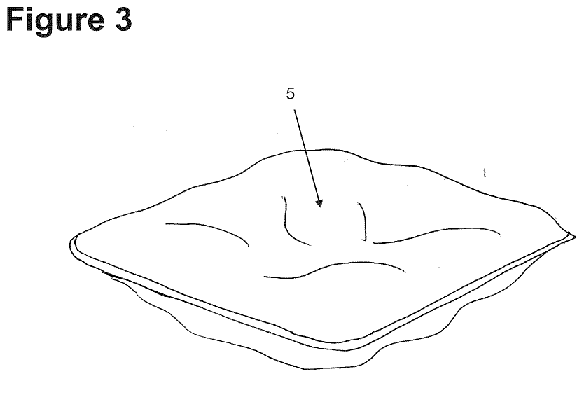

As indicated in the cross-section view of FIG. 2, there is one or more air filled bladder 5 inside each compartment 2. One of the bladders is shown more completely in FIG. 3 when separated from the rest of the cushion.

The membrane 6 of each bladder 5 is airtight and permanently sealed so that no further air can be added to or taken from it. Each bladder is preferably valveless.

In each case the membrane 6 may or may not have stretch to it.

Each bladder 5 is preferably filled with air to only 5%-35% of the volume, or potential volume, within its membrane 6. In some embodiments this range may be narrower, for example 10%-25% or 15%-20%. Most preferably each bladder is filled with air to 10%-15% of its volumetric capacity.

In some embodiments fluid other than air may be used for one, some, or all, of the bladders, for example an alternative gas or a liquid. However, gas, and especially air, is preferred.

The cushion is formed so that while each bladder is able to move within its own compartment 2, it is not able to move into any of the other compartments 2. This restricts the degree to which the cushion can be forced out of shape under body weight when in normal use.

One reason for giving the bladders only a partial fill is so that they are softer or provide more gentle cushioning when in use. It also means that the cushion is readily able to at least partially meld to the body shape of a person sitting on or resting their back against it. The degree of melding may be in proportion to the amount of weight or force being applied to it.

The cushion may be used for providing customised padding to a user, for example having more of fewer bladders 5 in the compartments depending on the person's needs. The more a compartment is filled with bladders the less ‘give’ it has. Some of the compartments may have more bladders than others of the compartments.

In some embodiments the cushion may have other than four of the compartments 2. For example, it may have two, three, five, six, eight or more of the compartments.

In some embodiments the cushion may be covered over with upholstery so that it forms an internal part of a seat.

In use, the cushion may form part of the backrest of a seat, for example a wheelchair. The seat's base and/or backrest may have one, or multiple, of the cushions. In some applications the cushion may be of an extended size so as to be, effectively, a mattress. However, these are just examples, and the same sort of cushion may be used in virtually any product that cushions are normally used in.

While some preferred embodiments of the invention have been described by way of example it should be appreciated that modifications and improvements can occur without departing from the scope of the following claims.

In terms of disclosure, this document hereby discloses each item, feature or step mentioned herein in combination with one or more of any of the other item, feature or step disclosed herein, in each case regardless of whether such combination is claimed.

1. A cushion comprising at least two compartments separated by a dividing wall, each compartment having one or more bladder, each bladder comprising a partial fill of air which takes up 5%-35% of the volumetric capacity of the bladder, the cushion being such that it can be opened to access the bladders and subsequently closed, the cushion also being such that when closed the bladders are not able to move into a neighbouring one of the compartments due, at least in part, to the wall.

2. A cushion, according to claim 1, wherein the fill in one or more of the bladders takes up 10%-20% of the volumetric capacity of said bladder(s).

3. A cushion, according to claim 1, wherein the fill in one or more of the bladders takes up 15%-25% of the volumetric capacity of said bladder(s).

4. A cushion, according to claim 1, wherein the fill in one or more of the bladders takes up 10%-15% of the volumetric capacity of said bladder(s).

5. A cushion according to claim 1, wherein the bladders are permanently sealed such that air cannot be added or to or removed from them.

6. A cushion according to claim 1, comprising two, three, four, five or six of the compartments, each compartment having one of more of the bladders.

7. A cushion according to claim 1, comprising four of the compartments, each compartment having one of more of the bladders.

8. A cushion according to claim 1, wherein at least one of the compartments contains more of the bladders than another of the compartments.

9. A seat comprising one or more cushion according to claim 1.

10. A seat according to claim 9, wherein the one or more cushion forms part of a backrest of the seat.

11. A seat according to claim 9, when used in a wheelchair.

12. A cushion according to claim 1, formed of sufficient size and with sufficient of the compartments and bladders to provide a mattress.

13. A cushion, according to claim 1, wherein;
a. one or more of the bladders takes up 10%-20% of the volumetric capacity of said bladder(s);
b. the bladders are permanently sealed such that air cannot be added or to or removed from them;
c. the cushion has two, three, four, five or six of the compartments, each compartment having one of more of the bladders; and
d. one of the compartments, or at least one of them, if there are more than two, contain(s) more of the bladders than another of the compartments.

14. A wheelchair comprising a cushion according to claim 1.

15. A wheelchair according to claim 14, wherein the cushion forms part of a backrest of the wheelchair.
